(19) United States
(12) Patent Application Publication
(10) Pub. No.: US 2026/0205958 A1
(43) Pub. Date: Jul. 16, 2026

(54) METHODS, ARCHITECTURES, APPARATUSES AND SYSTEMS FOR COORDINATED SPATIAL REUSE TRANSMISSIONS IN WIRELESS LOCAL AREA NETWORK SYSTEM

(71) Applicant: InterDigital Patent Holdings, Inc., Wilmington, DE (US)

(72) Inventors: Rui Yang, Greenlawn, NY (US); Hanqing Lou, Syosset, NY (US); Ying Wang, Easton, PA (US)

(21) Appl. No.: 19/018,416

(22) Filed: Jan. 13, 2025

(51) Int. Cl. H04W 52/34; H04W 52/36; H04W 88/08

(52) U.S. Cl. CPC H04W 52/346; H04W 52/367; H04W 88/08

(57) ABSTRACT

Methods, architectures, apparatuses, and systems directed to coordinated spatial reuse are described herein. In an embodiment, a first access point (AP) may be configured to receive from a second AP an announcement transmission comprising spatial reuse information. The first AP may be configured to transmit the spatial reuse information to a first station (STA) associated with the first AP. The first AP may be configured to measure a receive power of a first transmission detected from the second AP and determine a transmit power upper bound based on the spatial reuse information and the measured receive power of the first transmission. The first AP may be configured to transmit a second transmission at a transmit power that may satisfy a power condition associated with the transmit power upper bound, using a first set of resources being used for a third transmission of a second STA associated with the second AP.

### TECHNICAL FIELD

The present disclosure is generally directed to the fields of communications, software and encoding, including methods, architectures, apparatuses, and systems directed to coordinated spatial reuse transmissions in wireless local area network (WLAN) system.

### BACKGROUND

A WLAN in infrastructure basic service set (BSS) mode has an access point (AP) for the BSS and one or more stations (STAs) associated with the AP. The AP may have access or interface to a distribution system (DS) or another type of wired/wireless network carrying traffic in and out of the BSS. Embodiments described herein have been designed with the foregoing in mind.

### SUMMARY

Methods, architectures, apparatuses, and systems directed to coordinated spatial reuse transmission in WLAN system are described herein. In an embodiment, a first AP may include circuitry including any of transmitter, a receiver, a processor, and memory. The first AP may be configured to receive from a second AP an announcement transmission comprising spatial reuse information. In various embodiments, the first AP may be configured to transmit the spatial reuse information to a first STA associated with the first AP. In various embodiments, the first AP may be configured to measure a receive power of a first transmission detected from the second AP and determine a transmit power upper bound based on the spatial reuse information and the measured receive power of the first transmission. In various embodiments, the first AP may be configured to transmit a second transmission at a transmit power that may satisfy a power condition associated with the transmit power upper bound, using a first set of resources being used for a third transmission of a second STA associated with the second AP.

In an embodiment, a method implemented in a first AP may include receiving from a second AP an announcement transmission comprising spatial reuse information. In various embodiments, the method may include transmitting the spatial reuse information to a first STA associated with the first AP. In various embodiments, the method may include measuring a receive power of a first transmission detected from the second AP and determining a transmit power upper bound based on the spatial reuse information and the measured receive power of the first transmission. In various embodiments, the method may include transmitting a second transmission at a transmit power that may satisfy a power condition associated with the transmit power upper bound, using a first set of resources being used for a third transmission of a second STA associated with the second AP.

In an embodiment, a STA may include circuitry including a transmitter, a receiver, a processor, and memory. The STA may be configured to receive from a first AP an announcement transmission comprising spatial reuse information, the first STA being associated with the first AP. In various embodiments, the STA may be configured to measure a receive power of a first transmission detected from a second AP, the first STA not being associated with the second AP. In various embodiments, the STA may be configured to determine a transmit power upper bound based on the spatial reuse information and the measured receive power of the first transmission. In various embodiments, the STA may be configured to transmit a second transmission at a transmit power that may satisfy a power condition associated with the transmit power upper bound, using a first set of resources being used for a third transmission of a second STA associated with the second AP.

In an embodiment, a method implemented in a STA may include receiving from a first AP an announcement transmission comprising spatial reuse information, the first STA being associated with the first AP. In various embodiments, the method may include measuring a receive power of a first transmission detected from a second AP, the first STA not being associated with the second AP. In various embodiments, the method may include determining a transmit power upper bound based on the spatial reuse information and the measured receive power of the first transmission. In various embodiments, the method may include transmitting a second transmission at a transmit power that may satisfy a power condition associated with the transmit power upper bound, using a first set of resources being used for a third transmission of a second STA associated with the second AP.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a table describing a trigger frame format;

FIG. 3 is a table describing the common information field for IEEE 802.11ax;

FIG. 4 is a table describing the common information field for IEEE 802.11be;

FIG. 5 is a table describing the extremely high throughput (EHT) special user information field for IEEE 802.11be;

FIG. 6 is a diagram illustrating an example parameterized spatial reuse procedure in IEEE 802.11ax and IEEE 802.11be;

FIG. 7 is a diagram illustrating an example of multi-AP coordination;

FIG. 8 is a diagram illustrating an example coordinated spatial reuse;

FIG. 9 is a diagram illustrating a first example of general coordinated spatial reuse;

FIG. 10 is a diagram illustrating a first example of general coordinated spatial reuse;

FIG. 11 is a diagram illustrating an example of coordinated spatial reuse with multiple participating access points;

FIG. 12 is a diagram illustrating an example method for coordinated spatial reuse, implemented in a AP;

FIG. 13 is a diagram illustrating an example method for coordinated spatial reuse, implemented in a station; and

FIG. 14 is a diagram illustrating an example method for coordinated spatial reuse, implemented in an AP.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

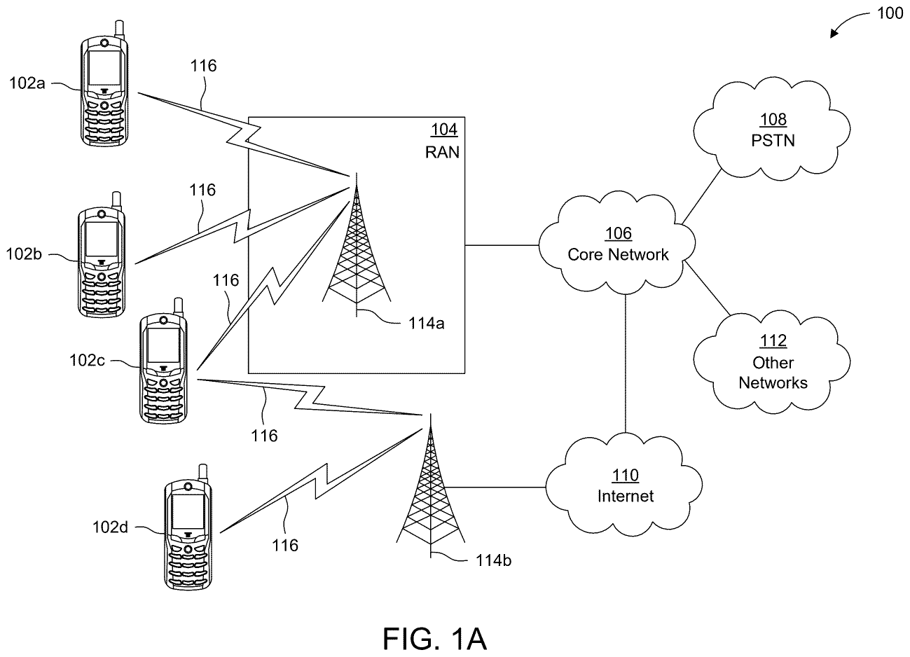

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discrete Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as Institute of electrical and electronics engineers (IEEE) 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized by WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 182a, 182b may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184a, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, carrier sense multiple access with collision avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off for a certain period of time before sensing again. One STA (e.g., only one station) may transmit at any given space, time and frequency resource in a given BSS.

In other representative embodiments, an AP may assign bandwidth resources over which associated STAs communicate with the AP. Bandwidth resources may include one or more channels (e.g., contiguous, or non-contiguous), one or more subchannels within a channel, one or more resource units (RUs) within an orthogonal frequency division multiple access (OFDMA) system, whereby assigned one or more RUs may be adjacent (e.g., contiguous) or non-contiguous, occupying one or more channels or subchannels, etc.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast Fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to the medium access control (MAC) layer, entity, etc.

High Efficiency Wireless (HEW or 802.11ax) STAs may support 20 MHz, 40 MHz, 80 MHz, and/or 160 MHz wide channels capable of transmission over 2.4 GHz, 5 GHz, and 6 GHz frequency bands using both OFDMA and multi-user multiple-input multiple-output (MU-MIMO) capabilities. OFDMA subcarrier modulation in HE STAs includes formats such as BPSK, QPSK, 16-QAM, 64-QAM, 256-QAM, 1024-QAM. The evolution of 802.11 to Extremely High Throughput (EHT) STAs extends to having 320 MHz wide channels.

While earlier generation 802.11 STAs (e.g., HEW or 802.11ax) could decide to transmit on one of the 2.4, 5.0, or 6 GHz bands, EHT STAs are further capable of multi-link operation (MLO), whereby data transmission between an EHT AP and non-AP STAs can occur over multiple bands simultaneously (e.g., 5 GHz and 6 GHz) thus increasing throughput and/or reliability. EHT STAs also benefit from a jump in QAM modulation from 1024-QAM to 4K-QAM, while enabling peak data rates of around 46 Gbps compared to the 9.6 Gbps capabilities of HEW STAs.

The next generation of 802.11 standard, 802.11bn (i.e., Ultra High Reliability—UHR) explores the possibility to improve reliability, support further reduced low latency traffic, further increase peak throughput, improved power saving capabilities and improve efficiency of the IEEE 802.11 network over HEW. These improvements are driven by technological advancements such as 360 immersive video, ultra-high-resolution streaming, online gaming, remote surgery, rapid expansion of Internet of Things (IoT), etc. Other 802.11 standard development examples are directed to areas such as: the application and management of artificial intelligence and machine learning (AIML) in WLANs, expanding WiFi communications into the millimeter-wave frequency band (integrated millimeter-wave—IMMW), energy harvesting based on of WiFi RF signals for facilitating WLAN communications of low-power IoT devices, and the randomization of MAC addresses in WLANs.

For the sake of clarity, satisfying, failing to satisfy a condition, and configuring condition parameter(s) are described throughout embodiments described herein as relative to a threshold (e.g., greater, or lower than) a (e.g., threshold) value, configuring the (e.g., threshold) value, etc. For example, satisfying a condition may be described as being above a (e.g., threshold) value, and failing to satisfy a condition may be described as being below a (e.g., threshold) value. Embodiments described herein are not limited to threshold-based conditions. Any kind of other condition and parameter(s) (such as e.g., belonging or not belonging to a range of values) may be applicable to embodiments described herein.

Throughout embodiments described herein, (e.g., configuration) information may be described as received by a WTRU from the network, for example, through system information or via any kind of protocol message. Although not explicitly mentioned throughout embodiments described herein, the same (e.g., configuration) information may be pre-configured in the WTRU (e.g., via any kind of pre-configuration methods such as e.g., via factory settings), such that this (e.g., configuration) information may be used by the WTRU without being received from the network.

Throughout embodiments described herein, the expression “the WTRU may be configured with a set of parameters” is equivalent or may be used interchangeably with “the WTRU may receive configuration information (e.g., from another network element (e.g., gNB)) indicating a set of parameters”. Throughout embodiments described herein, the expressions “the WTRU may report something”, and “the WTRU may be configured to report something”, is equivalent or may be used interchangeably with “the WTRU may transmit (e.g., reporting) information indicating something”. Throughout embodiments described herein, the expression “the WTRU may provide (/be provided) with a set of parameters (/something)” is equivalent or may be used interchangeably with “the WTRU may transmit (/receive) information indicating a set of parameters (/something)”.

In embodiments described herein, “a” and “an” and similar phrases are to be interpreted as “one or more” and “at least one”. Similarly, any term which ends with the suffix “(s)” is to be interpreted as “one or more” and “at least one”. The term “may” is to be interpreted as “may, for example”.

A symbol “/” (e.g., forward slash) may be used herein to represent “and/or”, where for example, “A/B” may imply “A and/or B”.

In embodiments described herein, “list of”, “set of” and “one or more of” may be used interchangeably.

In embodiments described herein, “identity” and “identifier” may be used interchangeably to refer to how a network element (or a WTRU) may be identified.

In embodiments described herein, a STA may refer to any of an AP STA and a non-AP STA. The architecture depicted at FIG. 1B for a WTRU 102 may be applicable more generally to any of an AP STA and a non-AP.

In embodiments described herein, the terms AP and AP STA may be used interchangeably.

In embodiments described herein, the terms frame and transmission may be used interchangeably.

In embodiments described herein, a transmission opportunity (TXOP) may refer to an interval of time during which a particular (e.g., quality-of-service (QoS)) STA may (e.g., have the right to) initiate frame exchange sequences onto the wireless medium (WM).

In embodiments described herein, spatial reuse (SR) refers to the transmission of a physical layer protocol data unit (PPDU) on the medium under certain conditions when a PPDU has been detected that would otherwise have prevented the transmission.

In embodiments described herein, a trigger based physical layer protocol data unit (TB PPDU) may refer to a PPDU transmitted with any of high efficiency (HE) TB PPDU (HE TB PPDU) format or extremely high throughput (EHT) TB PPDU (EHT TB PPDU) format.

In embodiments described herein, an overlapping basic service set (OBSS) may refer to a basic service set (BSS) operating on the same channel as the station's BSS and within (partly or wholly) its basic service area (BSA).

In embodiments described herein, a basic service set (BSS) color (BSS color) may refer to an identifier for a BSS or for a set of BSSs belonging to a multiple basic service set identifier (BSSID) set or a co-hosted BSSID set.

In embodiments described herein, a parametrized spatial reuse receive (PSRR) transmission refers to any transmission performed by a transmitter that may be an interference receiver in a context of spatial reuse.

In embodiments described herein, a parametrized spatial reuse transmit (PSRT) transmission refers to any transmission performed by a transmitter that may be an interference transmitter in a context of spatial reuse.

For the sake of clarity, embodiments are described herein with the example of PSRR and PSRT transmissions performed by any of an AP and a STA. Embodiments described herein are not limited to PSRR and PSRT transmissions and may be applicable to any kind of transmissions performed by any of an AP and a STA in a context of (e.g., parametrized) spatial reuse.

For the sake of clarity, embodiments are described herein with 20 MHz as an example of subchannel. Embodiments described herein are not limited to 20 MHz subchannels and may be applicable to subchannels of any size of the PPDU bandwidth (e.g., 40 MHz or any other size).

In embodiments described herein the terms “transmit power upper bound”, “transmit power maximum value”, “transmit power threshold”, “maximum transmit power” may be used interchangeably to refer to any power value allowing to avoid interferences with OBSS transmitters/receivers when performing spatial reuse.

A WLAN in infrastructure basic service set (BSS) mode has an access point (AP) for the BSS and one or more stations (STAs) associated with the AP. The AP may have access or interface to a distribution system (DS) or another type of wired/wireless network carrying traffic in and out of the BSS. Traffic to STAs originating from outside the BSS may arrive through the AP and may be delivered to the STAs. Traffic originating from STAs to destinations outside the BSS may be sent to the AP to be delivered to the respective destinations. Traffic between STAs within the BSS may (e.g., also) be sent through the AP where the source STA may send traffic to the AP and the AP may deliver the traffic to the destination STA.

Using the IEEE 802.11ac infrastructure mode of operation (described in IEEE Std 802.11™-2016), the AP may transmit a beacon on a fixed channel, e.g., the primary channel. This channel may be 20 MHz wide and may be the operating channel of the BSS. This channel may be used by the STAs to establish a connection with the AP. The channel access mechanism in an IEEE 802.11 system is based on carrier sense multiple access with collision avoidance (CSMA/CA). In this mode of operation, every STA, including the AP, may sense the primary channel. If the channel is detected to be busy, the STA backs off. Hence only one STA may transmit at any given time in a given BSS.

In IEEE 802.11n (described in IEEE Std 802.11™-2016), high throughput (HT) STAs may also use a 40 MHz wide channel for communication. This is achieved by combining the primary 20 MHz channel, with an adjacent 20 MHz channel to form a 40 MHz wide contiguous channel.

In 802.11ac (described in IEEE Std 802.11™-2016), very high throughput (VHT) STAs may support 20 MHz, 40 MHz, 80 MHz, and 160 MHz wide channels. The 40 MHz, and 80 MHz, channels may be formed by combining contiguous 20 MHz channels similar to IEEE 802.11n described herein. A 160 MHz channel may be formed by combining eight contiguous 20 MHz channels, or by combining two non-contiguous 80 MHz channels, which may also be referred to as an 80+80 configuration. For the 80+80 configuration, the data, after channel encoding, may be passed through a segment parser that may divide it into two streams. IFFT, and time domain, processing may be done on a (e.g., each) stream separately. The streams may be mapped on to the two channels, and the data may be transmitted. At the receiver, this mechanism is reversed, and the combined data may be sent to the MAC.

To improve spectral efficiency IEEE 802.11ac has introduced the concept for downlink multi-user MIMO (MU-MIMO) transmission to multiple STAs in the same symbol's time frame, e.g. during a downlink OFDM symbol. The use of downlink MU-MIMO may also be considered for IEEE 802.11ah. Considering that downlink MU-MIMO, as it is used in IEEE 802.11ac, uses the same symbol timing to multiple STAs, interference of the waveform transmissions to multiple STAs may not happen. In IEEE 802.11ac, (e.g., all) STAs involved in MU-MIMO transmission with the AP use the same channel or band, which limits the operating bandwidth to the smallest channel bandwidth that may be supported by the STAs which may be included in the MU-MIMO transmission with the AP.

Trigger frame was introduced firstly in IEEE 802.11ax and also used in IEEE 802.11be. Trigger frame may be used to allocate resources and trigger single or multi-user access, e.g., UL MU MIMO.

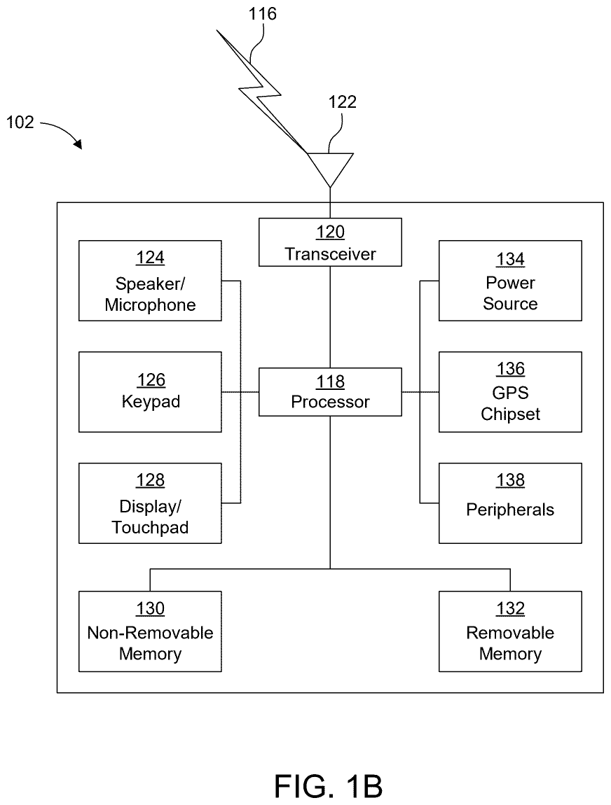

FIG. 2 is a table describing a trigger frame format. FIG. 2 describes the fields (name and size) of the trigger frame format.

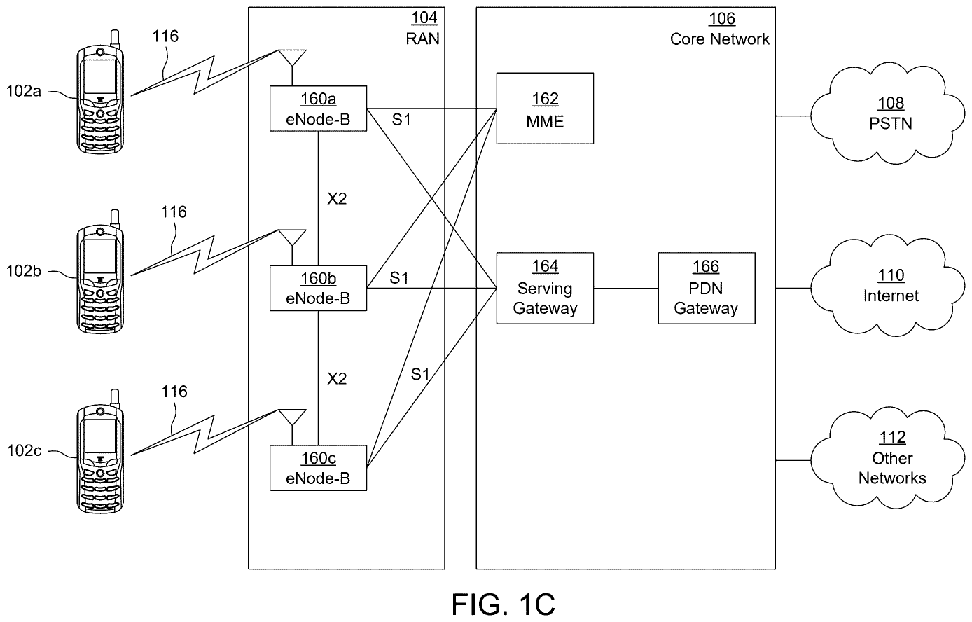

FIG. 3 is a table describing the common information field for IEEE 802.11ax. The common information field, referred to herein as common info field is described as sub-field names and sizes. The common info field for IEEE 802.11ax may be referred to as the high efficiency (HE) variant.

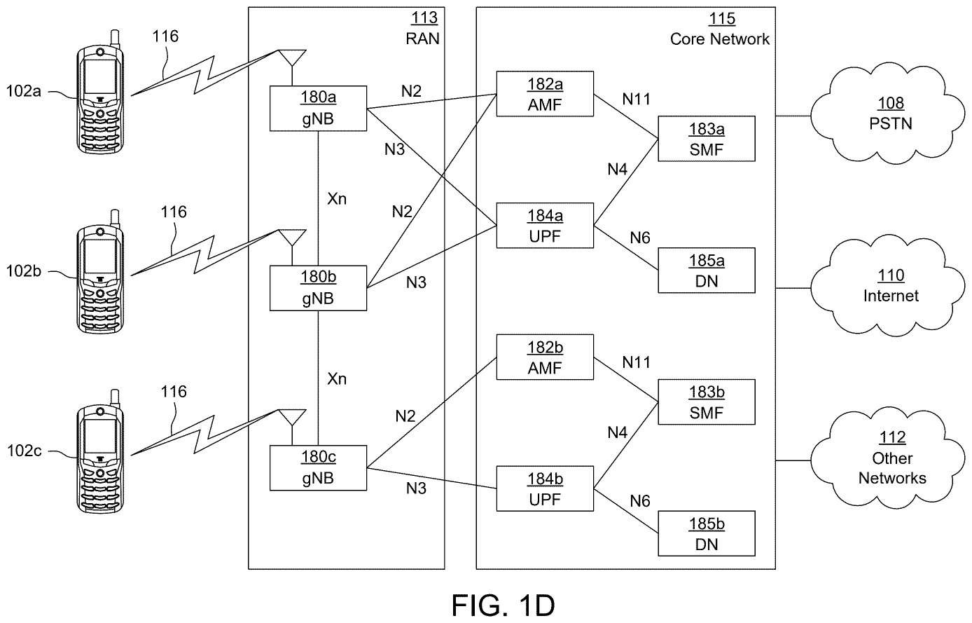

FIG. 4 is a table describing the common information field for IEEE 802.11be. The common information field, referred to herein as common info field is described as sub-field names and sizes. The common info field for IEEE 802.11be may be referred to as the extremely high throughput (EHT) variant.

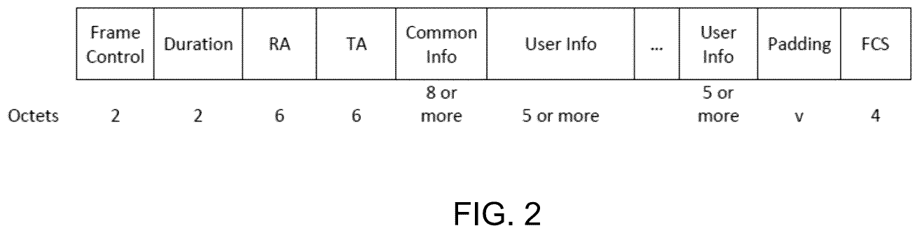

FIG. 5 is a table describing the EHT special user information field for IEEE 802.11be. The special user information field, referred to herein as special user info field is described in FIG. 5. In IEEE 802.11be, the special user info field is a user info field that does not carry user specific information and carries extended common information not provided in the common info field.

In IEEE 802.11ax and IEEE 802.11be, the common info field in a trigger frame may contain a “UL spatial reuse” subfield. In a EHT special user info field, there are two “spatial reuse” fields. Those fields are to be read by OBSS STAs to determine if they can use a spatial reuse feature, referred to herein as parameterized spatial reuse (PSR), e.g., if they are allowed. Those spatial reuse parameters may be included in, for IEEE 802.11ax, the high efficient signal A (HE-SIG-A) field of a TB PPDU and, for IEEE 802.11be, in the universal signal-2 (U-SIG-2) field. They may also be read by OBSS STAs to determine if they may use PSR, e.g., if they are allowed.

### Parametrized Spatial Reuse (PSR)

An EHT STA may identify (e.g., determine) a PSR opportunity if the following first and second conditions are met.

In an example, the first condition may be met if the STA receives a PSRR PPDU. For example, the first condition may be met if the EHT STA receives an indication (e.g., referred to as PHY-RXSTART.indication) corresponding to the reception of a PSRR PPDU that may be identified, for example, as an inter-BSS PPDU.

In an example, the second condition may be met if a (e.g., intended, total) transmit power of a PSRT PPDU (e.g., that may be queued for transmission) satisfies a power condition associated with a transmit power upper bound. For example, the power condition may be satisfied if the (e.g., intended, total) transmit power is less than or equal to the transmit power upper bound. For example, the second/power condition may be met if the (e.g., intended, total) transmit power of the PSRT PPDU in dBm meets the condition described in equation (1):

$$TxPowe {r}_{P SRT , total} \leq 10 \times {log}_{10} {N}_{P S R T , n o n p u n c} + {PSR}_{min} - R P {L}_{P S R R , 20 MHz} \qquad ( 1 )$$

Where:
TxPower_{PSRT, total} refers to the (e.g., intended, total) transmit power of the PSRT PPDU. By “total”, it is meant that the intended total transmit power refers the intended transmit power for all the (e.g., 20 MHz) subchannels.
N_{PSRT, nonpunc} refers to the number of non-punctured 20 MHz subchannels of the PSRT PPDU
RPL_{PSRR, 20 MHz} refers to the normalized received signal power in units of dBm/20 MHz, e.g., measured at the antenna connector in at least one 20 MHz subchannel. The measured 20 MHz subchannel(s) may be the subchannel(s) in which the preamble of the PSRR PPDU and the PSRT PPDU may be present.
PSRₘᵢₙ refers to the smallest PSR values within the bandwidth (BW) of PSRT PPDU obtained from at least one of (i) the value of the UL spatial reuse subfields in the common info field of the trigger frame of the PSRR PPDU, e.g., if the special user info field is not present in the trigger frame, (ii) the value of the EHT spatial reuse n subfield, in the special user info field of the trigger frame of the PSRR PPDU, e.g., if the special user info field is present in the trigger frame, and (iii) the value of the RXVECTOR parameter spatial reuse of the TB PPDU that may follow the PSRR PPDU.

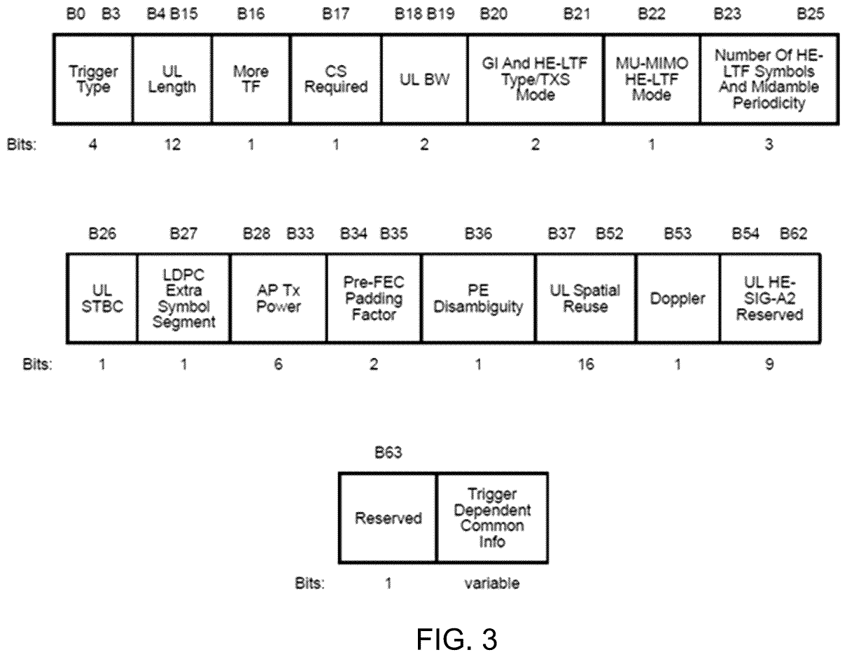

FIG. 6 is a diagram illustrating an example parameterized spatial reuse procedure in IEEE 802.11ax and IEEE 802.11be. Before STA_{OBSS-A} 61 may transmit a PSRT PPDU 610 (e.g., to another STA (e.g., STA_{OBSS-B} 62)), it may obtain the PSR parameters from any of a PSRR PPDU 611 and a HE/EHT TB PPDU 612 that may carry PSR information.

### Coordinated Multi-AP (MAP)

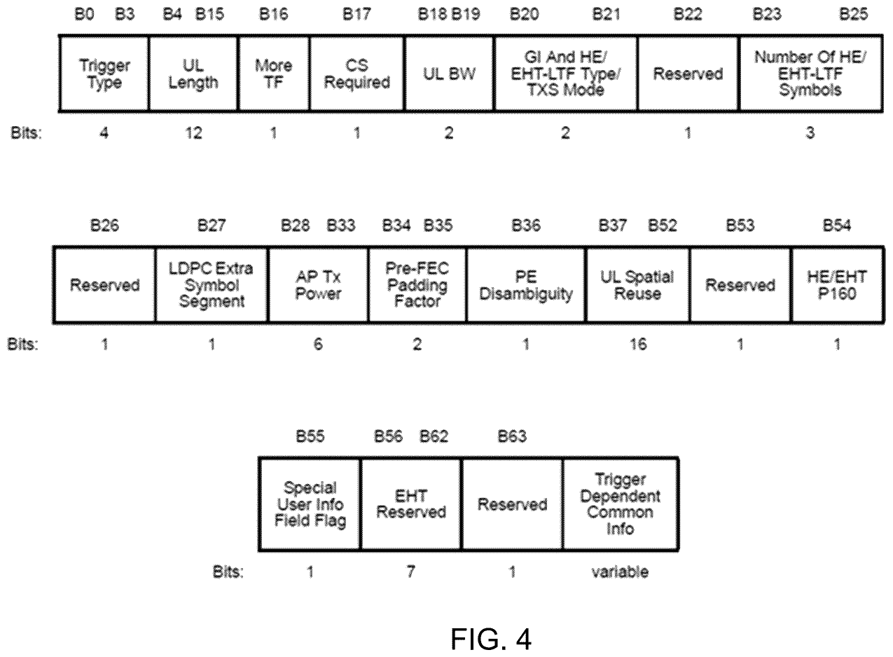

FIG. 7 is a diagram illustrating an example of multi-AP (MAP) coordination. An example of MAP coordination framework may be based on an AP being the initiating AP (I-AP) 70 (which may also be referred to as sharing AP) that may initiate the coordination with one or more other APs, being participating APs (P-APs) 71, 72 (which may also be referred to as shared AP). The I-AP 70 may first obtain a transmission opportunity (TXOP) and may share it with other P-APs 71 72, which may use this TXOP to transmit signals along with the transmission by I-AP 70 in a coordinated manner, such as any of coordinated beamforming, coordinated TDMA, coordinated spatial reuse, coordinated OFDMA, etc. These coordinated MAP operations may be based on an initial information exchange between the I-AP 70 and P-APs 71 72, as illustrated in FIG. 7.

In the current IEEE 802.11ax and IEEE 802.11be specifications, if an OBSS STA (e.g., STA_{OBSS-A} 61 shown in FIG. 6) would like to transmit a packet (e.g., PSRT PPDU 610 shown in FIG. 6) to another STA (e.g., STA_{OBSS-B} 62 shown in FIG. 6) in the same OBSS, it may (e.g., needs to) set its Tx power upper bound as shown in Equation (1) based on obtaining the PSR values from detecting and decoding any of the preamble of PSRR PPDU 611 carrying the trigger frame and the preamble of the TB PPDU 612. The response frame of PSRT PPDU transmitted from another STA (STA_{OBSS-B} 62) in the OBSS may also (e.g., need to) determine its Tx power by decoding one of those PPDUs 611, 612. If either of these OBSS STAs failed to detect the PSR values, the OBSS STAs may lose their service period (SP) (e.g., TXOP) opportunities. In an example, if the PSRR PPDU bandwidth is narrower than the bandwidth of PSRT PPDU, or if PSRR PPDU has punctured resource units (RUs), the current PSR scheme may cause interference to other OBSS transactions. Coordinated spatial reuse as described herein may allow to improve resource (time/frequency) usage in PSR by improving the capacity of OBSS STAs performing spatial reuse to transmit in a TXOP.

### Coordinated Spatial Reuse Transmissions Examples

Methods to enable coordinated spatial reuse transmissions using coordinated multi-AP (e.g., coordinated spatial reuse) in WLAN are described herein.

An AP may be used as a coordinated spatial reuse (C-SR) initiator AP (I-AP) to broadcast parameterized spatial reuse (PSR) information to other participating APs (P-AP). The P-AP(s) (which may be referred to herein as first APs) may respond to an I-AP (which may be referred to herein as second AP) and may pass (e.g., transmit) PSR information to their STAs. As the I-AP may transmit its DL frame, (e.g., all) P-APs and their associated STAs may measure receive (Rx) power. Any of the P-APs and their associated STAs may transmit their packet while STA(s) associated to I-AP may transmit (e.g., at the same time, using the same medium).

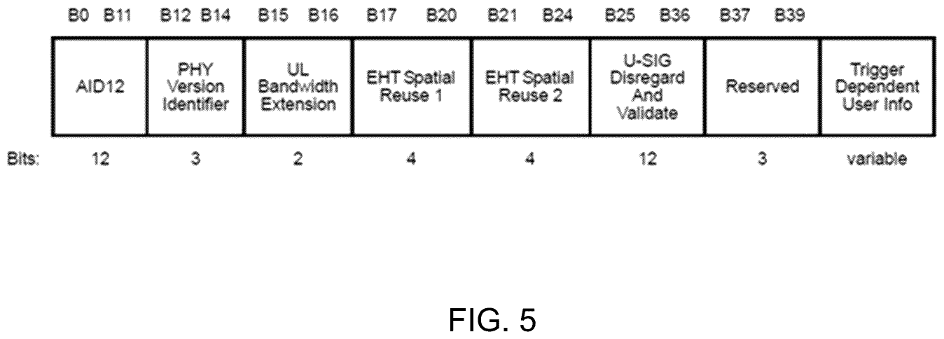

One or more APs may form an MAP group. They may negotiate the coordinated schemes and parameters to be used. They may exchange frames to enable or disable coordinated spatial reuse. Above-mentioned procedures and frame exchanges may happen before the example PSR transmission procedure described herein in relation to FIGS. 8-11.

Under the MAP framework, (e.g., certain) information exchange may take place before the transmissions in (e.g., all) BSSs may start. For the purposes of spatial reuse (SR), some information to enable the spatial reuse may be propagated (e.g., broadcasted) from I-AP, which may allow the spatial reuse, to P-APs. If the I-AP disallows the SR, it could use the same mechanism to achieve it.

FIG. 8 is a diagram illustrating an example coordinated spatial reuse during a TB PPDU transmission. As shown at FIG. 8, the I-AP 820 may start a trigger based (TB) uplink transmission process and may allow the spatial reuse in an OBSS with one of its P-APs 810. The I-AP 820 may acquire the wireless medium through CSMA/CA or any other channel access procedures. In an example, as a part of coordination process, the I-AP 820 may announce (e.g., transmit), via any of an announcement frame, a part of general-purpose announcement frame, and an initial control frame, its intention to start a TB-based coordinated spatial reuse operation (TB-based Co-SR). The announcement frame 821, which may be referred to as PSRR Tx announcement frame, may include the following SR related information, which may be referred to herein as PSR information (PSR Info) herein.

In an example, PSR information may include/indicate any of (i) the type of the triggering operation, (ii) one or more access point identifiers (e.g., P-AP IDs) allowed to participate in the (e.g., coordinated) spatial reuse, (iii) a BSS color, (iv) one or more station identifiers to be involved in the (e.g., coordinated) spatial reuse, (v) a length of a solicited trigger based transmission, (vi) whether or not a subsequent trigger frame may be scheduled for transmission, (vii) a frequency domain puncture pattern trigger based transmission, (viii) a combined transmit power of (e.g., all) antennas to be used to transmit the first transmission, (ix) a sub channel allocation per participating AP, (x) (e.g., quantized) PSR values for subchannels, (xi) a maximum tolerable interference power, and (xii) a starting time of the transmission (e.g., of the PSRR PPDU 822).

The PSR information may indicate the BSS color where any access point that may be allowed to participate in the (e.g., coordinated) spatial reuse, may reside.

The one or more one or more station identifiers (indicated in the PSR information) to be involved in the (e.g., coordinated) spatial reuse may include the associated STA IDs that may be the potential receivers of the PSRR PPDU 822 and the potential transmitters of the solicited TB PPDU 823. Considering that the TB PPDU 823 may cause interference to the PSRT PPDU 813, this may enable the receivers 811 of the PSRT PPDU 813 in the OBSS to access the interference from the TB PPDU 822 and determine (e.g., decide) if they can receive the PSRT PPDU 813 and if yes, suggest (e.g., indicate) to the P-AP 810 what modulation and coding scheme (MCS) to use in the PSRT PPDU 813.

The length of a solicited trigger-based transmission (indicated in the PSR information) may comprise the value of the L-SIG LENGTH field of the solicited TB PPDU. For example, this value may be used by the P-AP as an upper bound for the duration of its potential upcoming PSRT PPDU 813 e.g., plus short interframe space (SIFS) duration e.g., plus the duration of solicited response 814 (e.g., acknowledge (ACK), block acknowledge (BA), etc.). This parameter may be similar to “UL Length” field in the common info field of existing HE/EHT trigger frames. It may be used to allow spatial reuse in non-trigger-based transmission scenarios. In an example, it may be included in the PSR information in addition to be included the HE/EHT trigger frame. In another example, it may be included in the PSR information and not included in the HE/EHT trigger frame.

The parameter indicating whether or not a subsequent trigger frame may be scheduled for transmission, may be similar to the “More TF” field in the common info field of existing HE/EHT trigger frame. It may be used to allow spatial reuse in non-trigger-based transmission scenarios. In an example, it may be included in the PSR information in addition to be included the HE/EHT trigger frame. In another example, it may be included in the PSR information and not included in the HE/EHT trigger frame.

The PSR information may indicate the bandwidth and/or frequency domain puncture patten TB PPDU. This parameter may be similar to “UL BW” field in the common info field of existing HE/EHT trigger frame. It may be used to allow spatial reuse in non-trigger-based transmission scenarios. In an example, it may be included in the PSR information in addition to be included the HE/EHT trigger frame. In another example, it may be included in the PSR information and not included in the HE/EHT trigger frame.

The AP's combined transmit power (e.g., at the transmit antenna connector) of (e.g., all) the antennas (e.g., to be) used to transmit the triggering PPDU may be indicated in the PSR information in units of dBm/20 MHz (or 40 MHz).

If more than one P-APs are participating to C-SR, the subchannel allocation for each P-AP may be provided (e.g., indicated in the PSR information). For example, this parameter may be similar to the “AP Tx Power” field in the common info field of existing HE/EHT trigger frame. It may be used to allow spatial reuse in non-trigger-based transmission scenarios. In an example, it may be included in the PSR information in addition to be included the HE/EHT trigger frame. In another example, it may be included in the PSR information and not included in the HE/EHT trigger frame.

The (e.g., quantized) PSR values for (e.g., all) subchannels may be indicated in the PSR information in e.g., any subchannels, such as any of 20 MHz and 40 MHz channels. The resolution of the subchannel may be signaled (e.g., indicated) at the same time. For example, this parameter may be similar to “UL spatial reuse” field in the common info field of existing HE/EHT trigger frame. A PSR value of zero may indicate that coordinated PSR may not be allowed. A PSR value different from zero may be used to allow coordinated spatial reuse scenarios. For example, a PSR value different from zero may indicate that coordinated PSR may be allowed based on the indicated non-zero PSR value. In an example, the UL spatial reuse field may be included in the PSR information in addition to be included the HE/EHT trigger frame. In this example, the PSR value included in the announcement frame may be used to indicate allow or disallow coordinated PSR, and, if coordinated PSR is allowed, the value of PSR (e.g. to be used for calculating the Tx power upper bound as described herein). The PSR value included in the trigger frame may be used to allow or disallow PSR from legacy Wi-Fi devices (e.g., 11ax and 11be devices). If coordinated SR is allowed (e.g., based on a non-zero PSR value indicated in the announcement frame), the PSR value in the triggering frame may be set to disallowed PSR such that the legacy devices may not create interference during the coordination PSR. Alternatively, if coordinated SR is allowed (e.g., based on a non-zero PSR value indicated in the announcement frame), the PSR value in the triggering frame may be set to allowed PSR (e.g., any value different from disallowed PSR) thus enabling legacy devices to participate in the coordinated PSR. In another example, the UL spatial reuse field may be included in the PSR information and not included in the HE/EHT trigger frame. In an example, (e.g., instead of the PSR values), the (e.g., quantized) maximum tolerable interference power, P_{maxI}, per any of 20 MHz and 40 MHz may be included/indicated in the PSR information.

The starting time of the transmission of PSRR PPDU 822 carrying the trigger frame (indicated in the PSR information) may be the relative time from the start of the end of PSR announcement frame 821. The P-AP 810 and its associated STAs 811 may measure the Rx power during the PSRR PPDU 822 transmission from the I-AP 820. In an example, the PSR information may indicate the starting time of the TB PPDU 823 transmission, when the OBSS transmission may start.

In an example, the PSR information may indicate a signal to disallow or prohibit of using spatial reuse. This signal may indicate its P-APs not to participate to any spatial reuse process, e.g., even if they are also the P-APs of other I-AP(s).

In an example, the PSRR Tx announcement frame may (e.g., also) serve as a polling frame to check whether the P-AP may participate the TB-based coordinated spatial reuse operation. It may be transmitted to one or more APs in the MAP group.

In an example, on reception of the PSRR Tx announcement frame, the P-AP may determine if it may attend the TB-based coordinated spatial reuse operation based on the information it may have received and traffic status e.g., at the moment. If the P-AP determines not to participate, it may respond (e.g., transmit) a frame to the I-AP indicating rejecting the opportunity. If the P-AP determines to participate, it may transmit a frame to the I-AP indicating accepting the opportunity. The P-AP may transmit another frame to its intended receiver(s) to indicate the TB-based Co-SR information. This frame may be a polling frame that may solicit a response from its intended receivers to confirm who may be the (e.g., eventual) PSRT PPDU receivers. In one method, the P-AP may transmit the two frames in two PPDUs in a sequential way. For example, the P-AP may transmit the response to the I-AP in the first PPDU and a number of interframe space (xIFS) time later, the P-AP may transmit to its intended receiver in a second PPDU. In another method, the P-AP may transmit the two frames in an aggregated MAC PDU (MPDU) which may be carried in a PPDU. In an example, a frame may carry information for the response to the I-AP and the information to its intended STAs together. Following any of the above described PPDU(s) sent by the P-AP, after an xIFS interval, the intended receiver 811 of the P-AP may respond (e.g., transmit) e.g., in a short response frame whether it may receive the (e.g., potential) incoming PSRT PPDU from the P-AP. The receiver 811 may make the decision based on (e.g., both) the interference it may cause to the I-AP (e.g., when it may be transmitting an ACK 814 to the PSRT PPDU 813) and the interference it may suffer from the TB PPDU 823. To assess the interference from the TB PPDU 823, the receiver 811 may (e.g., need to) have a measure of the received power from the TB PPDU transmitter. In an example, this measure may be based on history knowledge of the interference sources. In another example, the TB PPDU transmitter may send a frame after the PSRR Tx announcement frame to provide a real-time measurement opportunity.

In an example, as shown at block 815, the P-AP 810 in the OBSS may decode the PSR information. The P-AP 810 may forward PSR information to its associated STAs 811 that may be the intended receivers for its (e.g., DL) transmission e.g., expecting sending a response (e.g., ACK) back. After the STA 811 associated with the P-AP 810 may have received the PSR information, the STA 811 may (e.g., also) compute (e.g., determine) the Tx power allowing to avoid the interference to I-AP 820 when the I-AP 820 may receive the TB PPDU 823. To avoid the interference to I-AP 820 when the I-AP 820 may receive the TB PPDU 823, (e.g., both) P-AP 810 and its associated STA 811 may measure (as shown at block 816) the received power, or received signal strength indicator (RSSI), when the I-AP may transmit the PSRR PPDU 822 carrying the trigger frame. In one example method (not shown in FIG. 8), the STA 811 associated with P-AP 810 may transmit a response frame to P-AP 810 before the PSRR PPDU 822 carrying the trigger frame to indicate it may have received the Tx PSR parameters and may be ready (e.g., able) to receive during the transmission of the TB PPDU 823. Based on the PSR information and the measured received power from PSRR PPDU, (e.g., both) the P-AP 810 and its associated STA 811 may compute (e.g., determine) a transmit (Tx) power upper bound per 20 MHz as shown in Equation (1). Using the notations of Equation (1), the transmit (Tx) power upper bound per 20 MHz may be referred to as PSRₘᵢₙ−RPL_{PSRR, 20 MHz}. In another example, the Tx power upper bound may be determined per 40 Mhz subchannel and may be referred to as e.g., PSRₘᵢₙ−RPL_{PSRR, 40 MHz}). In an example, the Tx power upper bound shown in Equation (1), may be a function of Tx power of PSRR PPDU and the tolerable interference power at I-AP as per Equation (2):

$${TxPower}_{PSRT , total} \leq 10 \times {log}_{10} {N}_{PSRT , nonpunc} + {TxPower}_{PSRR , 20 MHz} - RP {L}_{PSRR , 20 MHz} + {P}_{maxI , 20 MHz} \qquad ( 2 )$$

where TxPower_{PSRR, 20 MHz}−RPL_{PSRR, 20 MHz} may represent per 20 MHz pathloss (in dB) between P-AP 810 and I-AP 820, and where P_{maxI, 20 MHz} may represent the maximum tolerable interference power per 20 MHz.

In various examples, the Tx power upper bound may be determined per (e.g., 20 MHz) subchannel (e.g., referring to as TxPower_{PSRR, 20 MHz}−RPL_{PSRR, 20 MHz}+P_{maxI, 20 MHz}), or as total/overall Tx power upper bound for all (e.g., 20 MHz) subchannels (e.g., referring to as 10×log₁₀ N_{PSRT, nonpunc}+TxPower_{PSRR, 20 MHz}−RPL_{PSRR, 20 MHz}+P_{maxI,20 MHz}), where 20 MHz is used herein as an example of subchannel, which may be of any size of the PPDU bandwidth.

In an example, any of the P-AP 810 and its associated STA 811 may perform a transmission 813, 814 at an (e.g., intended) transmit power that may satisfy a power condition associated with the determined Tx power upper bound described herein. For example, the power condition may be satisfied if the (e.g., intended) transmit power is less than or equal to the determined Tx power upper bound described herein. The transmission 813, 814 may be performed, based on the power condition being satisfied, using a set of resources being used for e.g., the TB PPDU 823 transmission.

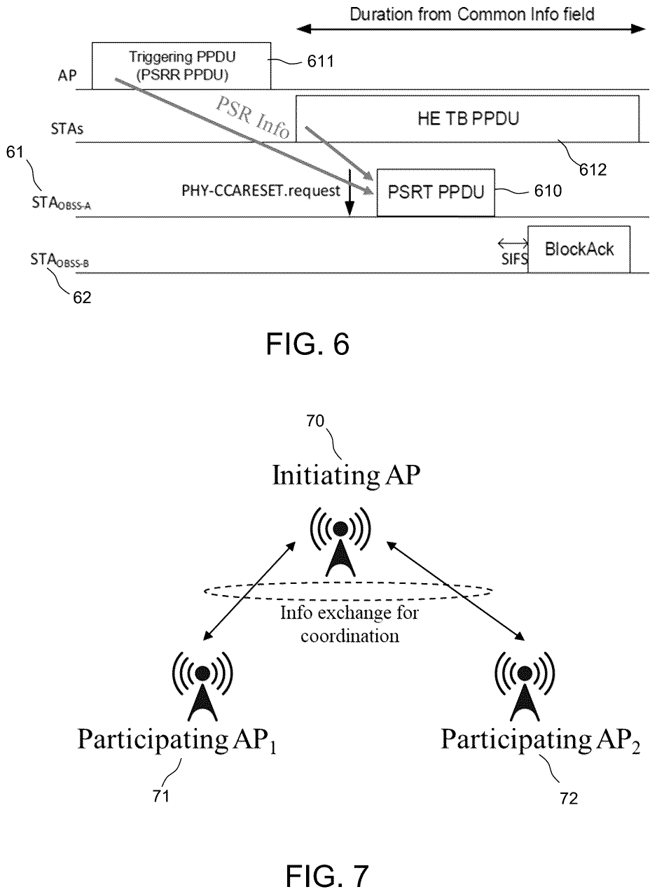

FIG. 9 is a diagram illustrating a first example of general coordinated spatial reuse. The coordinated spatial reuse transmission illustrated in FIG. 8 may be generalized as illustrated by FIG. 9. For example, the transmission in the BSS with I-AP 920 may be any I-DL transmission 922 followed by an I-UL transmission 923. The I-DL transmission 922 may enable any of RSSI and pathloss measurement to be performed by any transmitters in the OBSS with P-AP 910. In an example, the transmission in the OBSS with P-AP 910 may start with a P-DL transmission 913 followed by a P-UL transmission 914.

In an example, the P-DL transmission 913 and the P-UL transmission 914 may use a (e.g., same) first set of frequency resource, the I-DL transmission 922 and the I-UL transmission 923 may use a (e.g., same) second set of frequency resource, and there may be overlapping (e.g., common) frequency resources between the first set and the second set of frequency resources. In general, a participating uplink (P-UL) transmission 914 may use part of the spectrum used for participating downlink (P-DL) transmissions 913, which may be part of the spectrum that may be used by I-UL transmissions 923.

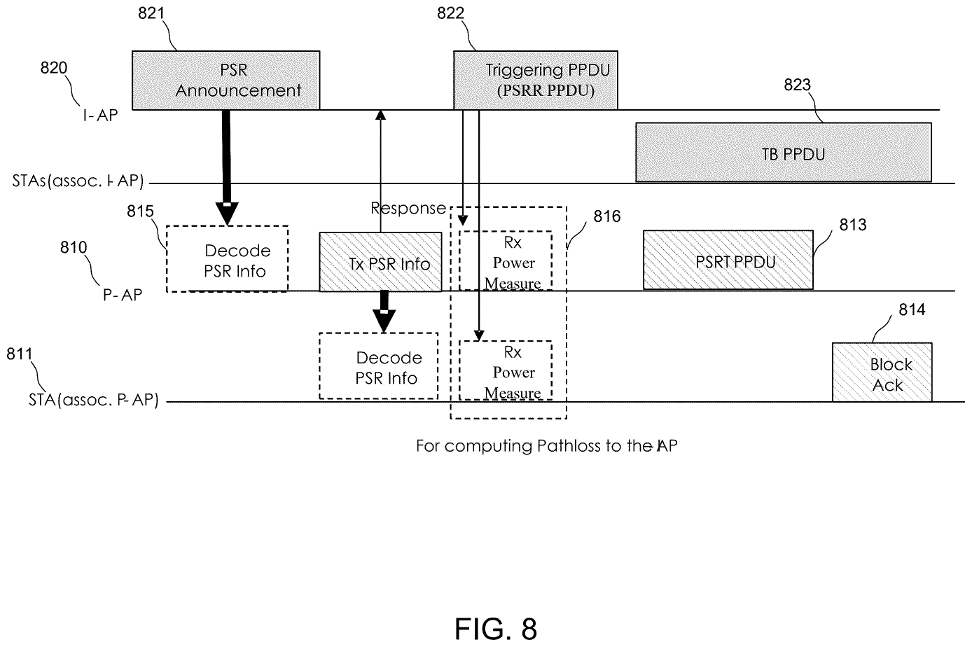

FIG. 10 is a diagram illustrating a second example of general coordinated spatial reuse. For example, the transmission in the BSS with I-AP 1020 may be any I-DL transmission 1022 followed by an I-UL transmission 1023. The I-DL transmission 1022 may enable any of RSSI and pathloss measurement to be performed by any transmitters in the OBSS with P-AP 1010. In an example, the transmission in the OBSS with P-AP 1010 may start with a P-UL transmission 1013 followed by a P-DL transmission 1014.

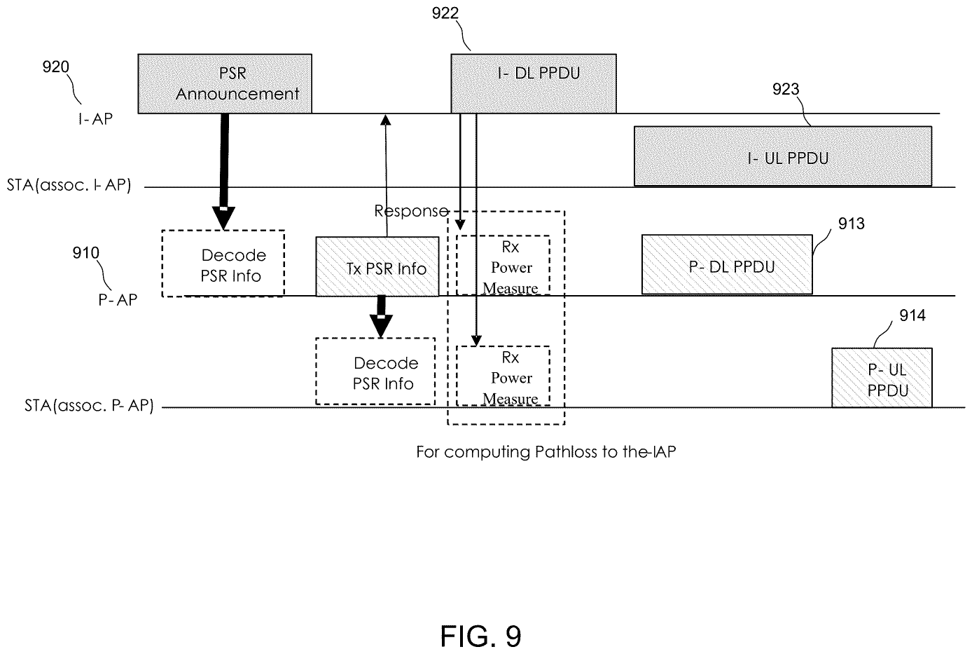

FIG. 11 is a diagram illustrating an example of coordinated spatial reuse with multiple participating access points. The methods illustrated via FIG. 8, FIG. 9 and FIG. 10 may be expanded to multiple P-APs 1110, 1130. To avoid large overhead in time due to information exchanges and measurements to be performed among multiple P-APs 1110, 1130, using spatial or frequency domain multiplexing may be performed, as illustrated in FIG. 11. In this example, the BSS with I-AP 1120 may be to receive an I-UL transmission 1122 from one of its associated STA. In an example, when the I-AP 1120 performs (e.g., transmits) the PSR announcement 1121, the I-AP 1120 may include (e.g., information indicating) the resource allocation (e.g., any of subchannels, subblocks) for (e.g., each) OBSSs to avoid interferences among P-APs 1110, 1130. The P-APs 1110, 1130 and their associated STAs may use those resources for any of PSR information transmission, data transmission, and feedback. As shown in FIG. 11, the transmission direction in BSSs with P-APs 1110, 1130 may be different, e.g., one in UL and the other in DL.

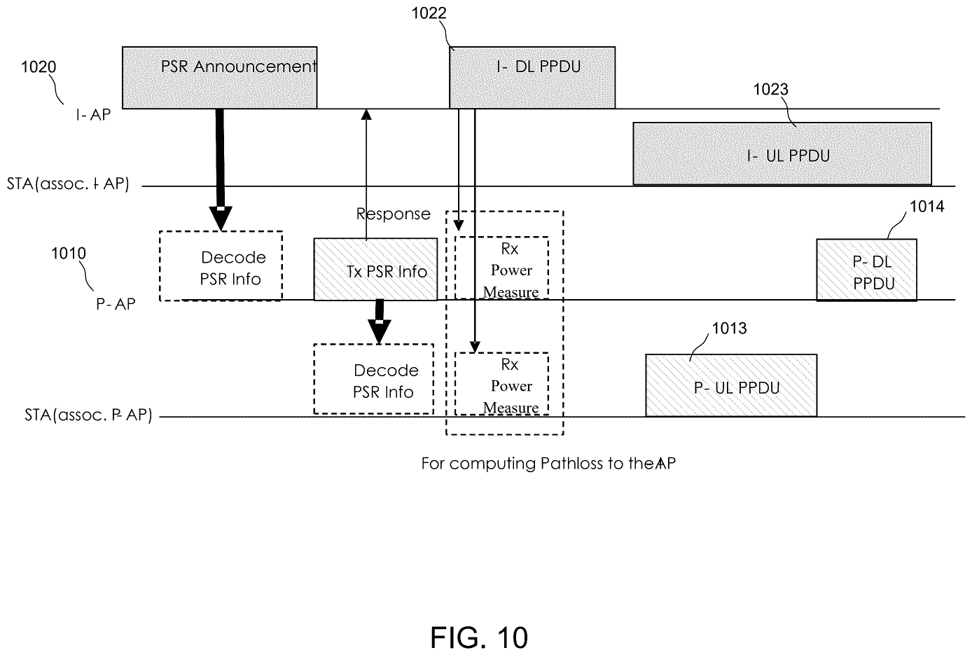

FIG. 12 is a diagram illustrating an example method 1200 for coordinated spatial reuse, implemented in a first AP. The first AP may include circuitry including any of transmitter, a receiver, a processor, and memory. The circuitry may be configured to carry out the method 1200. As shown at 1210, the method 1200 may include receiving from a second AP an announcement transmission comprising spatial reuse information. As shown at 1220, the method 1200 may include transmitting the spatial reuse information to a first STA associated with the first AP. As shown at 1230, the method 1200 may include measuring a receive power of a first transmission detected from the second AP. As shown at 1240, the method 1200 may include determining a transmit power upper bound based on the spatial reuse information and the measured receive power of the first transmission. As shown at 1250, the method 1200 may include transmitting a second transmission at a transmit power that may satisfy a power condition associated with the transmit power upper bound, using a first set of resources being used for a third transmission of a second STA associated with the second AP.

In various embodiments, the second transmission may use resources that may extend beyond the first set of resources being used for the third transmission. There may be any kind of overlap (e.g., partially overlapping, totally being included, totally including) between the resources used for the second transmission and the resources used for the third transmission.

In various embodiments, transmitting the second transmission may comprise transmitting the second transmission to the first STA.

In various embodiments, the method 1200 may further include receiving a fourth transmission from the first STA, using a second set of resources being used for the third transmission of the second STA.

In various embodiments, the fourth transmission may use resources that may extend beyond the second set of resources being used for the third transmission. There may be any kind of overlap (partially overlapping, totally being included totally including) between the resources used for the fourth transmission and the resources used for the third transmission.

In various embodiments, the fourth transmission may be received in response to the second transmission.

In various embodiments, the fourth transmission may be received before transmitting the second transmission, and the second transmission may be transmitted in response to the fourth transmission.

In various embodiments, the first set of resources being used for the third transmission may comprise a first set of frequency resources being used for the third transmission.

In various embodiments, the first set of resources being used for the third transmission may comprise a first set of time and frequency resources being used for the third transmission.

In various embodiments, the second set of resources being used for the third transmission may comprise a second set of frequency resources being used for the third transmission.

In various embodiments, the second set of resources being used for the third transmission may comprise a second set of time and frequency resources being used for the third transmission.

In various embodiments, the transmit power may satisfy the transmit power upper bound in a case where the transmit power is less than or equal to the transmit power upper bound.

In various embodiments, the third transmission is from a different BSS.

In various embodiments, the spatial reuse information may indicate any of (i) a type of triggering operation, (ii) one or more access point identifiers allowed to participate in a spatial reuse, (iii) a basic service set (BSS) color, (iv) one or more station identifiers to be involved in the spatial reuse, (v) a length of a solicited trigger based transmission, (vi) whether or not a subsequent trigger frame may be scheduled for transmission, (vii) a frequency domain puncture pattern trigger based transmission, (viii) a combined transmit power of (e.g., all) antennas to be used to transmit the first transmission, (ix) a sub channel allocation per participating AP, (x) quantized PSR values for subchannels, (xi) a maximum tolerable interference power, and (xii) a starting time of the first transmission.

In various embodiments, the first AP and the second AP may belong to a MAP group.

In various embodiments, the method 1200 may further include sending a response to the second AP in response to the announcement transmission. In various embodiments, the response may indicate accepting to participate in spatial reuse.

In various embodiments, the response and the spatial reuse information may be transmitted in two different PPDUs.

In various embodiments, the response and the spatial reuse information may be aggregated for transmission in a single PPDU.

In various embodiments, the transmit power upper bound may be a function of a path loss between the first AP and the second AP.

In various embodiments, the first transmission may comprise a PSRR PPDU.

In various embodiments, the second transmission may comprise a PSRT PPDU.

In various embodiments, the third transmission may comprise a trigger-based PPDU.

In various embodiments, the first AP may be a participating AP in a coordinated spatial reuse and the second AP may be an initiating AP in the coordinated spatial reuse.

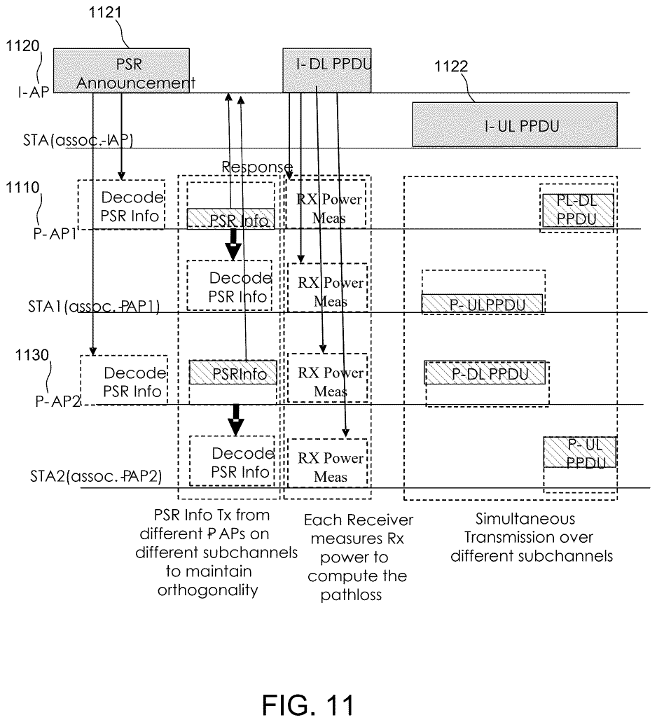

FIG. 13 is a diagram illustrating an example method 1300 for coordinated spatial reuse, implemented in a first STA. The first STA may include circuitry including any of transmitter, a receiver, a processor, and memory. The circuitry may be configured to carry out the method 1300. As shown at 1310, the method 1300 may include receiving from a first AP an announcement transmission comprising spatial reuse information, the first STA being associated with the first AP. As shown at 1320, the method 1300 may include measuring a receive power of a first transmission detected from a second AP, the first STA not being associated with the second AP. As shown at 1330, the method 1300 may include determining a transmit power upper bound based on the spatial reuse information and the measured receive power of the first transmission. As shown at 1340, the method 1300 may include transmitting a second transmission at a transmit power that may satisfy a power condition associated with the transmit power upper bound, using a first set of resources being used for a third transmission of a second STA associated with the second AP.

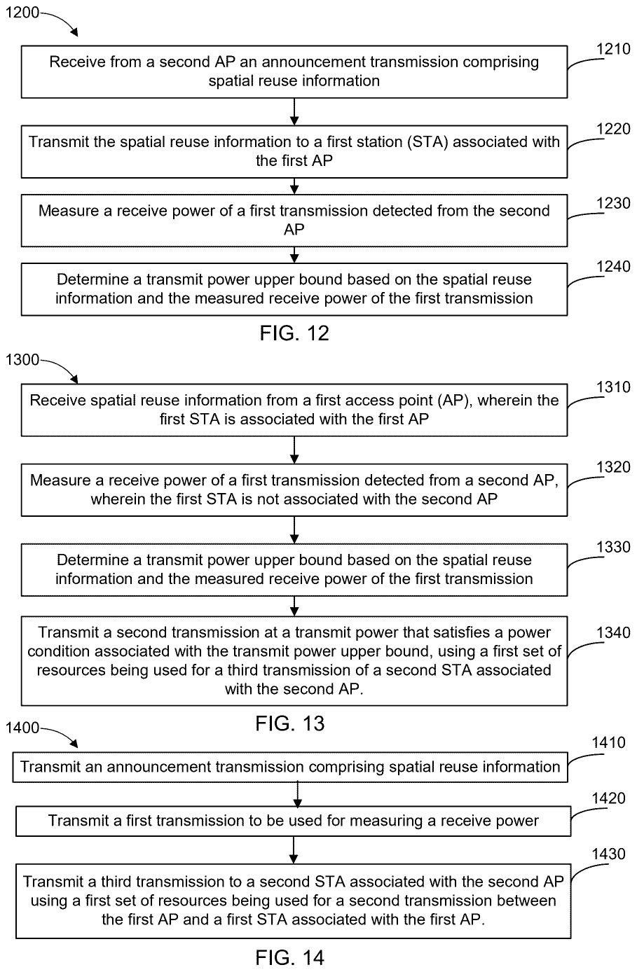

FIG. 14 is a diagram illustrating an example method 1400 for coordinated spatial reuse, implemented in a second AP. The second AP may include circuitry including any of transmitter, a receiver, a processor, and memory. The circuitry may be configured to carry out the method 1400. As shown at 1410, the method 1400 may include transmitting/broadcasting an announcement transmission comprising spatial reuse information. As shown at 1420, the method 1400 may include transmitting a first transmission to be used by any of a first AP and a first STA associated with the first AP for measuring a receive power. As shown at 1430, the method 1400 may include transmitting a third transmission to a second STA associated with the second AP using a first set of resources being used for a second transmission between the first AP and a first STA associated with the first AP.

Any variant described in relation to the method 1200 illustrated at FIG. 12 may also be applicable to any of the methods 1300 and 1400 illustrated at FIG. 13 and FIG. 14.

While not explicitly described, embodiments described herein may be employed in any combination or sub-combination. For example, the present principles are not limited to the described variants, and any arrangement of variants and embodiments can be used.

Besides, any characteristic, variant or embodiment described for a method is compatible with an apparatus device comprising means for processing the disclosed method, with a device comprising circuitry, including any of a transmitter, a receiver, a processor, and memory, the circuitry being operable (e.g., configured) to process the disclosed method, with a computer program product comprising program code instructions and with a non-transitory computer-readable storage medium storing program instructions. Besides, any characteristic, variant or embodiment described for a WTRU is compatible with an (e.g., infrastructure) network element of the cellular network.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

The content of each of the following references is incorporated by reference herein in its entirety:
IEEE Std 802.11™-2016: Wireless LAN Medium Access Control (MAC) and Physical Layer (PHY) Specifications
IEEE P802.11ax™/D8.0: Wireless LAN Medium Access Control (MAC) and Physical Layer (PHY) Specifications
19/1262r15, Specification framework for TGbe
20/1429r2, Enhanced Trigger Frame for EHT Support, Qualcomm
20/764r0, Trigger Consideration, NXP
20/831r0 Trigger Frame for Frequency-domain A-PPDU Support, Samsung
20/840r0 Backward compatible EHT trigger frame, Huawei
20/1192r0 TB PPDU Format Signaling in Trigger Frame, Wilus
20/828r1 RU Allocation Subfield Design for EHT Trigger Frame, Samsung
20/1429r4, Enhanced Trigger Frame for EHT Support, Qualcomm
21/0269r1 PSR-based SR Normalization Discussion
21/0440r2 PDT-EHT-PSR-based-SR

1. A first access point (AP) comprising circuitry, including a transmitter, a receiver, a processor, and memory, configured to:
receive from a second AP an announcement transmission comprising spatial reuse information;
transmit the spatial reuse information to a first station (STA) associated with the first AP;
measure a receive power of a first transmission detected from the second AP;
determine a transmit power upper bound based on the spatial reuse information and the measured receive power of the first transmission; and
transmit a second transmission at a transmit power that satisfies a power condition associated with the transmit power upper bound, using a first set of resources being used for a third transmission of a second STA associated with the second AP.

2. The first AP of claim 1, wherein being configured to transmit the second transmission comprises being configured to transmit the second transmission to the first STA.

3. The first AP of claim 1, further configured to receive a fourth transmission from the first STA, using a second set of resources being used for the third transmission of the second STA.

4. The first AP of claim 3, wherein the fourth transmission is received in response to the second transmission.

5. The first AP of claim 3, wherein the fourth transmission is received before transmitting the second transmission, and wherein the second transmission is transmitted in response to the fourth transmission.

6. The first AP of claim 1, wherein the first set of resources being used for the third transmission comprises a first set of time and frequency resources being used for the third transmission.

7. The first AP of claim 3, wherein the second set of resources being used for the third transmission comprises a second set of time and frequency resources being used for the third transmission.

8. The first AP of claim 1, wherein the transmit power satisfies the power condition associated with the transmit power upper bound in a case where the transmit power is less than or equal to the transmit power upper bound.

9. The first AP of claim 1, wherein the third transmission is from a different basic service set (BSS).

10. The first AP of claim 1, wherein the spatial reuse information indicates any of (i) a type of triggering operation, (ii) one or more access point identifiers allowed to participate in a spatial reuse, (iii) a basic service set (BSS) color, (iv) one or more station identifiers to be involved in the spatial reuse, (v) a length of a solicited trigger based transmission, (vi) whether or not a subsequent trigger frame is scheduled for transmission, (vii) a frequency domain puncture pattern trigger based transmission, (viii) a combined transmit power of all antennas to be used to transmit the first transmission, (ix) a sub channel allocation per participating AP, (x) quantized parametrized spatial reuse (PSR) values for subchannels, (xi) a maximum tolerable interference power, and (xii) a starting time of the first transmission.

11. The first AP of claim 1, wherein the first AP and the second AP belong to a multi access point (MAP) group.

12. The first AP of claim 1, further configured to send a response to the second AP in response to the announcement transmission, wherein the response indicates accepting to participate in spatial reuse.

13. The first AP of claim 12, wherein the response and the spatial reuse information are transmitted in two different physical layer protocol data units (PPDUs).

14. The first AP of claim 12, wherein the response and the spatial reuse information are aggregated for transmission in a single PPDU.

15. The first AP of claim 1, wherein the transmit power upper bound is a function of a path loss between the first AP and the second AP.

16. The first AP of claim 1, wherein the first transmission comprises a parametrized spatial reuse receive (PSRR) PPDU.

17. The first AP of claim 1, wherein the second transmission comprises a parametrized spatial reuse transmit (PSRT) PPDU.

18. The first AP of claim 1, wherein the third transmission comprises a trigger based PPDU.

19. A method implemented in a first access point (AP), the method comprising:
receiving from a second AP an announcement transmission comprising spatial reuse information;
transmitting the spatial reuse information to a first station (STA) associated with the first AP;
measuring a receive power of a first transmission detected from the second AP;
determining a transmit power upper bound based on the spatial reuse information and the measured receive power of the first transmission; and
transmitting a second transmission at a transmit power that satisfies a power condition associated with the transmit power upper bound, using a first set of resources being used for a third transmission of a second STA associated with the second AP.

20. A first station (STA) comprising circuitry, including a transmitter, a receiver, a processor, and memory, configured to:
receive spatial reuse information from a first access point (AP), wherein the first STA is associated with the first AP;
measure a receive power of a first transmission detected from a second AP, wherein the first STA is not associated with the second AP;
determine a transmit power upper bound based on the spatial reuse information and the measured receive power of the first transmission; and
transmit a second transmission at a transmit power that satisfies a power condition associated with the transmit power upper bound, using a first set of resources being used for a third transmission of a second STA associated with the second AP.
